(19) United States
(12) Patent Application Publication
(10) Pub. No.: US 2014/0072887 A1
(43) Pub. Date: Mar. 13, 2014

(54) OXIDATION OF FUEL CELL ELECTRODE CONTAMINANTS

(71) Applicants: Kelly A. O'Leary, Ionia, NY (US); Balasubramanian Lakshmanan, Pittsford, NY (US); Robert C. Reid, Livonia, NY (US); Robert J. Moses, Farmington, NY (US); Robert S. Foley, Rochester, NY (US)

(72) Inventors: Kelly A. O'Leary, Ionia, NY (US); Balasubramanian Lakshmanan, Pittsford, NY (US); Robert C. Reid, Livonia, NY (US); Robert J. Moses, Farmington, NY (US); Robert S. Foley, Rochester, NY (US)

(73) Assignee: GM GLOBAL TECHNOLOGY OPERATIONS LLC, Detroit, MI (US)

(21) Appl. No.: 13/612,384

(22) Filed: Sep. 12, 2012

(51) Int. Cl. H01M 8/06; H01M 16/00

(52) U.S. Cl. 429/410

(57) ABSTRACT

A system for oxidizing contaminants on both the cathode and anode electrodes in a fuel cell stack by applying a suitable voltage potential across the electrodes that causes the oxidation. The system includes a battery and an electrical converter electrically coupled to the battery. The electrical converter is configured to assist in providing an oxidation potential to the fuel cell stack by converting electrical power from the battery at a time effective to oxidize contaminants on the cathode or anode electrodes in the stack. The electrical converter provides a positive potential to the fuel cell stack to oxidize contaminants on the cathode electrodes and provides a negative potential to the fuel cell stack to oxidize contaminants on the anode electrodes. If the battery is a high voltage battery, then the converter is a power converter and if the battery is a low voltage battery, then the converter is boost converter.

### BACKGROUND OF THE INVENTION

1. Field of the Invention

This invention relates generally to a system and method for removing contaminants from fuel cell electrodes and, more particularly, to a system and method for oxidizing contaminants on a fuel cell electrode by applying a suitable positive potential to the fuel cell stack to oxidize cathode electrode contaminants and applying a suitable negative potential to the fuel cell stack to oxidize anode electrode contaminants.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between the two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

When a fuel cell system is in an idle mode, such as when the fuel cell vehicle is stopped at a stop light, where the fuel cell stack is not generating power to operate system devices, air and hydrogen are generally still being provided to the fuel cell stack, and the stack is generating output power. Providing hydrogen to the fuel cell stack when it is in the idle mode is generally wasteful because operating the stack under this condition is not producing very much useful work, if any.

For these and other fuel cell system operating conditions, it may be desirable to put the system in a stand-by mode where the system is consuming little or no power, the quantity of hydrogen fuel being used is minimal and the system can quickly recover from the stand-by mode so as to increase system efficiency and reduce system degradation. U.S. patent application Ser. No. 12/723,261, titled, Standby Mode for Optimization of Efficiency and Durability of a Fuel Cell Vehicle Application, filed Mar. 12, 2010, assigned to the assignee of this application and herein incorporated by reference, discloses one process for putting a fuel cell system on a vehicle in a stand-by mode to conserve fuel.

In automotive applications, there are a large number of start and stop cycles required over the life of the fuel cell system, where 40,000 start and stop cycles would be considered reasonable. Leaving a stack in an oxygen-rich atmosphere at shut-down results in a damaging air/hydrogen event within the cells causing catalytic corrosion at both shut-down and start-up, where 2 to 5 μV of degradation per start and stop cycle is plausible. Thus, the total degradation over 40,000 start and stop cycle events is on the order of 100 or more mV. If the stack is left with a hydrogen/nitrogen mixture at shut-down, and the system is restarted before appreciable concentrations of oxygen have accumulated, cell corrosion during the shut-down and subsequent restart is avoided.

It has been proposed in the art to reduce the frequency of the air/hydrogen events referred to above by periodically injecting hydrogen into the anode side of a fuel cell stack after the stack has been shut-down, sometimes referred to as hydrogen-in-park. For example, U.S. patent application Ser. No. 12/636,318, filed Dec. 11, 2009, titled, Fuel Cell Operation Methods for Hydrogen Addition After Shutdown, assigned to the assignee of this application and herein incorporated by reference, discloses such a method for injecting hydrogen into the anode side of a fuel cell stack during system shut-down. However, at some point, the hydrogen injection process needs to be stopped at which time air will begin to diffuse into the stack. It is necessary to terminate the hydrogen sustaining technique to conserve hydrogen or low voltage battery power for an extended vehicle off times. For these situations, the slow diffusion of oxygen back into the stack causes the catalytic corrosion referred to above.

There are a number of mechanisms from the operation of a fuel cell system that cause permanent loss of stack performance, such as loss of catalyst activity, catalyst support corrosion and pinhole formation in the cell membranes. However, there are other mechanisms that can cause stack voltage that are substantially reversible, such as the cell membranes drying out, catalyst oxide formation, and build-up of contaminants on both the anode and cathode electrodes in the stack.

In order for a PEM fuel cell system to be commercially viable, there generally needs to be a limitation of the noble metal loading, i.e., platinum or platinum alloy catalyst, on the fuel cell electrodes to reduce the overall system cost. As a result, the total available electro-chemically active surface area of the catalyst may be limited or reduced, which renders the electrodes more susceptible to contamination. The source of the contamination can be from the anode and cathode reactant gas feed streams including humidification water, or generated within the fuel cells due to the degradation of the MEA, stack sealants and/or bipolar plates. One particular type of contaminate includes anions, which are negatively charged, such as chlorine or sulfates, such as SO₄^{2.} The anions tend to adsorb onto the platinum catalyst surface of the electrode during normal fuel cell operation when the cathode potential is typically over 650 mV, thus blocking the active site for oxygen reduction reaction, which leads to cell voltage loss. Moreover, if proton conductivity is also highly dependent on a contaminate free platinum surface, such as nano-structured thin film (NSTF) type electrodes, additional losses are caused by the reduced proton conductivity.

It is known in the art to remove some of the oxide formations and the build-up of contaminants, as well as to rehydrate the cell membranes, to recover losses in cell voltage in a fuel cell stack. U.S. patent application Ser. No. 12/580,863, titled, In-Situ Fuel Cell Stack Reconditioning, filed Oct. 16, 2009, assigned to the assignee of this application and herein incorporated by reference, discloses one such procedure for reconditioning a fuel cell stack to recover reversible voltage loss that includes increasing the water content of the cells.

It is also known in the art that some of the contaminants that form on the electrodes in a fuel cell stack can be removed from the electrode by oxidizing the contaminant. In order to oxidize the contaminants on the electrodes, it is necessary to raise the potential across the electrodes to a high enough voltage to provide that oxidation. However, the fuel cell stack within a typical fuel cell system on a vehicle is limited in power and is unable to achieve the necessary voltage potential. Therefore, it is desirable to provide some mechanism for providing that higher voltage potential to provide the oxidation to recover stack voltage loss.

### SUMMARY OF THE INVENTION

In accordance with the teachings of the present invention, a system and method are disclosed for oxidizing contaminants on both the cathode and anode electrodes in a fuel cell stack by applying a suitable voltage potential across the electrodes that causes the oxidation. The system includes a direct current power source, for example, a battery and an electrical converter electrically coupled to the battery. The electrical converter is configured to assist in providing an oxidation potential to the fuel cell stack by converting electrical power from the battery at a time effective to oxidize contaminants on the cathode or anode electrodes in the fuel cell stack. The electrical converter provides a positive potential to the fuel cell stack to oxidize contaminants on the cathode electrodes and provides a negative potential to the fuel cell stack to oxidize contaminants on the anode electrodes. If the battery is a high voltage battery, then the converter is a power converter and if the battery is a low voltage battery, then the converter is boost converter.

Additional features of the present invention will become apparent from the following description and appended claims, taken in conjunction with the accompanying drawings.

### BRIEF DESCRIPTION OF THE DRAWING

FIG. 1 is a schematic block diagram of a fuel cell system that includes an electrical device for increasing the voltage potential in a fuel cell stack.

### DETAILED DESCRIPTION OF THE EMBODIMENTS

The following discussion of the embodiments of the invention directed to a system and method for oxidizing contaminants on the electrodes in a fuel cell stack is merely exemplary in nature, and is in no way intended to limit the invention or its applications or uses. For example, the system and method of the invention described herein has particular application for a fuel cell system on a vehicle. However, as will be appreciated by those skilled in the art, that system and method may have other applications.

The present invention proposes a mechanism for oxidizing the contaminants on both the cathode electrodes and the anode electrodes in a fuel cell stack during times when a system controller determines adequate hydrogen is present in the stack, but no load on the stack. This oxidation process is caused by applying a high enough voltage potential across the stack cells, such as 1.1 volts, that causes an electro-chemical reaction on the platinum catalyst that removes organic contaminants. The higher potential overcomes the catalyst thermodynamic energy level that binds the contaminants to the platinum catalyst. The oxidation process generates by-products, such as gases, that are flushed out during operation of the system.

Various operating modes may exist during operation of a fuel cell system on a vehicle that satisfy this condition, where the oxidation of the contaminants can occur for some period of time, for example, a few seconds up to possibly a few minutes. One known system operating mode that may satisfy this condition is the stand-by mode, referred to above, where the vehicle may be in an idle condition, such as stopped at a stop-light, but a small amount of hydrogen is being provided to the stack. Another known system operating mode that may satisfy this condition is the hydrogen-in-park mode, also referred to above, where hydrogen is being provided to the stack when the system is shut down to prevent damaging air/hydrogen events in the cells. It is noted however that these two modes may be suitable to perform the operation discussed herein, but other system operating modes where the amount of hydrogen in the stack is known and the system is not drawing power from the stack may also occur.

If the control algorithm determines that electrode oxidation should be performed based on time, fuel cell stack performance, etc., then the next time the system is in the proper condition, a voltage potential is provided to the fuel cell stack that is high enough to provide the oxidation while the loads are disconnected from stack. For oxidation of contaminants on the cathode electrode, a positive potential needs to be applied to the fuel cell stack and for oxidization of the contaminants on the anode electrode, a negative potential needs to be applied to the fuel cell stack. In the example discussed below, the potential is provided by a battery on the vehicle.

Most fuel cell vehicles are hybrid vehicles that employ a supplemental power source in addition to the fuel cell stack, such as a high voltage DC battery or an ultracapacitor. The power source provides supplemental power for the various vehicle auxiliary loads, for system start-up and during high power demands when the fuel cell stack is unable to provide the desired power. The fuel cell stack provides power to an electrical traction motor through a DC high voltage electrical bus for vehicle operation. The battery provides supplemental power to the electrical bus during those times when additional power is needed beyond what the stack can provide, such as during heavy acceleration. For example, the fuel cell stack may provide 70 kW of power. However, vehicle acceleration may require 100 kW of power. The fuel cell stack is used to recharge the battery or ultracapacitor at those times when the fuel cell stack is able to provide the system power demand. The generator power available from the traction motor during regenerative braking is also used to recharge the battery or ultracapacitor. In the hybrid vehicle discussed above, a bi-directional DC/DC converter is sometimes employed to match the battery voltage to the voltage of the fuel cell stack.

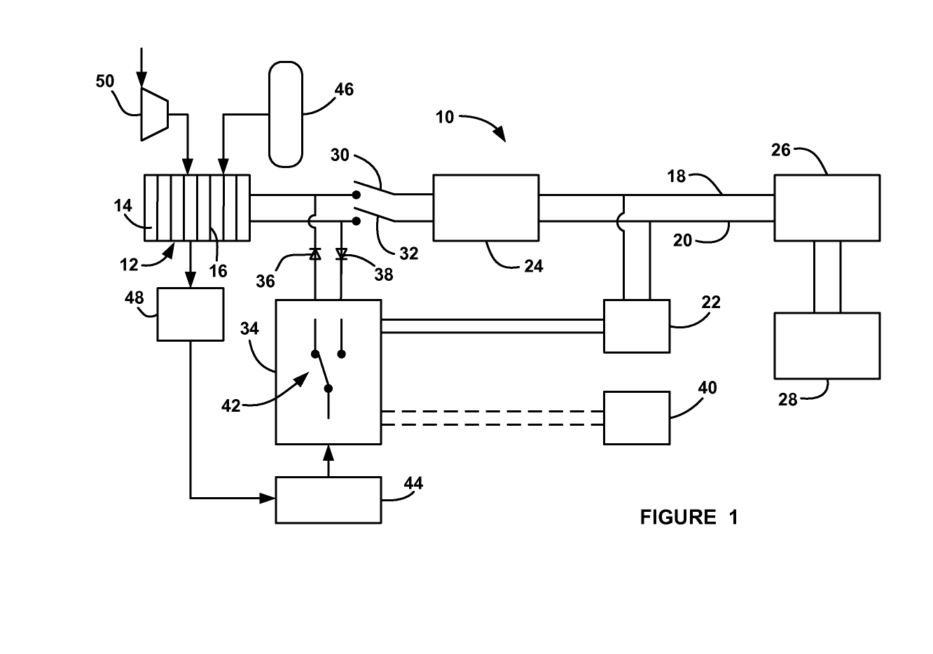

FIG. 1 is a schematic block diagram of a fuel cell system 10 including a fuel cell stack 12 that has particular application as a vehicle fuel cell system. The fuel cell stack 12 includes a number of fuel cells 14 suitable for the particular application, where anode and cathode electrodes 16 are provided at opposite sides of the fuel cells 14. A hydrogen source 46 provides hydrogen fuel to the anode side of the fuel cell stack 12. An air compressor 50 provides air to the cathode side of the fuel cell stack 12. The cathode sub-system and the anode sub-system in the fuel cell system 10 would include various valves, injectors, hoses, etc. provided in various configurations that are not shown here, and are not necessary for a proper understanding of the invention.

A voltage monitoring circuit 48 monitors the stack voltage, measures the minimum and maximum cell voltages of the fuel cells 14 and calculates an average cell voltage. The voltage monitoring circuit 48 can be any suitable device for the purposes discussed herein many of which are known to those skilled in the art. A system controller 44 controls the operation of the fuel cell system 10 and receives the voltage values from the voltage monitoring circuit 48.

The fuel cell system 10 also includes a high voltage electrical bus represented by positive and negative voltage lines 18 and 20 that are electrically coupled to the fuel cell stack 12. The fuel cell system 10 includes a high voltage battery 22 also electrically coupled to the bus lines 18 and 20 that supplements the power provided by the fuel cell stack 12 in a manner that is well understood by those skilled in the art. The system 10 also includes a DC/DC boost converter 24 electrically coupled to the high voltage bus lines 18 and 20 between the fuel cell stack 12 and the high voltage battery 22 that provides DC voltage matching also in a manner well understood by those skilled in the art. An inverter 26 is electrically coupled to the high voltage bus lines 18 and 20 to convert the DC current provided thereon to an AC signal suitable to operate an AC traction motor 28 to propel the vehicle. The operation of an inverter for this purpose is also well understood by those skilled in the art. Contactor switches 30 and 32 are provided in the lines 18 and 20, respectively, to disconnect the fuel cell stack 12 from the rest of the electrical system of the fuel cell system 10.

The fuel cell system 10 also includes an electrical converter 34 electrically coupled to the high voltage bus lines 18 and 20 between the contactor switches 30 and 32 and the fuel cell stack 12. The converter 34 is controlled by the controller 44 in the manner as discussed herein. For those times when it is desirable or necessary to recapture lost voltage of the fuel cell stack 12 by oxidizing and removing contaminants on the anode and cathode electrodes 16, and the system 10 is in the proper condition, such as the stand-by mode or a suitable shut-down mode, the electrical converter 34 provides the potential to the bus lines 18 and 20 so that the voltage on the stack 12 is high enough so that each cell 14 within the stack 12 has about a 1.1 volt potential thereon. Diodes 36 and 38 can be provided in the lines connecting the bus lines 18 and 20 to the converter 34 that prevent electrical flow from the bus lines 18 and 20 to the converter 34. When the stack contactor switches 30 and 32 are open during the oxidation operation and the electrical converter 34 is turned on, then the potential is added to the bus lines 18 and 20 directly to the stack 12.

The voltage potential applied to the stack 12 during the oxidation process discussed herein can only be performed when the maximum cell voltage, i.e., the fuel cell with the highest voltage, is below a maximum cell voltage threshold and the minimum cell voltage, i.e., the fuel cell with the lowest voltage, is above a minimum cell voltage threshold. The controller 44 monitors the maximum and minimum cell voltages provided by the voltage monitoring circuit 48 and only allows the converter 34 to provide the oxidation potential to the fuel cell stack 12 if this criteria is met.

In one embodiment, the electrical converter 34 is a power converter that converts the high voltage battery power from the battery 22 to a voltage potential suitable for the oxidation process as discussed herein. In an alternate embodiment, the electrical converter 34 is a boost converter that converts a low voltage, typically 12 volts, from a 12 volt battery 40 to a high enough voltage potential to provide the oxidation. The low voltage battery 40 drives auxiliary low power loads on the vehicle, such as lights, climate control devices, radio, etc. Power converters and boost converters suitable for this purpose are well known to those skilled in the art and are readily available.

In order to perform the contamination oxidation process discussed herein, it is necessary that hydrogen be present in the anode side of the fuel cell stack 12, and how much hydrogen is present, so that a reference potential across the cells 14 in the stack 12 can be determined. One time that the amount of hydrogen is in both the anode and cathode sides of the fuel cell stack 12, and where no power is being drawn from the fuel cell stack 12, is during system shut-down when the hydrogen sustaining process to reduce catalyst corrosion on the electrode is being performed, as discussed above in the '318 application. Once that reference potential across the cells 14 in the stack 12 is known, then the amount of additional voltage that is necessary to reach the oxidation voltage is provided by the electrical converter 34 to provide the oxidation. The oxidation potential may be about 1.1 volts, but can be anywhere in a range between open circuit voltage and 1.6 volts. That reference potential is typically less than 0.1 volts, which is calculated based on a hydrogen concentration estimation, thus requiring the converter 34 to provide the adequate power or current necessary to meet the oxidation voltage.

As discussed above, the oxidation process of the electrodes 16 in the fuel cell stack 12 needs to be done separately for the anode electrodes and the cathode electrodes. When the oxidation process is being performed for the cathode electrodes 16, a positive potential is provided to the bus lines 18 and 20 by the converter 34, where the converter 34 only needs to provide the addition potential above the reference potential. For those times when the oxidation is being performed for the anode electrodes 16, the converter 34 is switched in polarity in any suitable manner, where many circuits would be well understood by those skilled in the art, so that the polarity provided to the bus lines 14 and 16 is reversed to provide the negative potential that adds to the negative potential at the anode electrode 16. A switching network 42 is shown within the converter 34 as a general representation how the converter 34 may switch the polarity of the potential to the fuel cell stack 12.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a high voltage bus;
a fuel cell stack electrically coupled to the high voltage bus, said fuel cell stack including a plurality of fuel cells each having an anode electrode and cathode electrode;
a hydrogen source providing hydrogen to the fuel cell stack;
a DC/DC converter electrically coupled to the high voltage bus;
a system load electrically coupled to the high voltage bus opposite to the fuel cell stack from the DC/DC converter;
contactor switches electrically coupled to the high voltage bus between the fuel cell stack and the DC/DC converter, said contactor switches electrically disconnecting the fuel cell stack from the high voltage bus;
a battery electrically coupled to the high voltage bus; and
an electrical converter electrically coupled to the high voltage bus between the contactor switches and the fuel cell stack and being electrically coupled to the battery, said electrical converter being configured to assist in providing an oxidation potential to the fuel cell stack by converting electrical power from the battery at a time effective to oxidize contaminants on the cathode or anode electrodes in the fuel cell stack and when the contactor switches are open to disconnect a load from the fuel cell stack, said effective time being a time when a known amount of hydrogen is being provided to the fuel cell stack from the hydrogen source.

2. The system according to claim 1 wherein the electrical converter is configured to provide a positive potential to the fuel cell stack to oxidize contaminants on the cathode electrodes.

3. The system according to claim 1 wherein the electrical converter is configured to provide a negative potential to the fuel cell stack to oxidize contaminants on the anode electrodes.

4. The system according to claim 1 wherein the battery is a high voltage battery electrically coupled to the high voltage bus opposite to the fuel cell stack from the DC/DC converter, said electrical converter being a power converter that converts the high voltage from the high voltage battery to the oxidation potential.

5. The system according to claim 1 wherein the battery is a 12 volt battery and the electrical converter is a boost converter that converts and increases the voltage potential from the 12 volt battery to the oxidation potential.

6. The system according to claim 1 wherein the known amount of hydrogen in the fuel cell stack defines a reference potential within the stack, said oxidation potential being the reference potential plus a voltage potential provided by the electrical converter.

7. The system according to claim 6 wherein the effective time is a time that the fuel cell system is shut-down and hydrogen is being periodically provided to the stack.

8. The system according to claim 6 wherein the effective time is a time that the fuel cell system is in a stand-by mode where the system is operational.

9. The system according to claim 1 further comprising a voltage monitoring device, said voltage monitoring device monitoring a maximum cell voltage and a minimum cell voltage of the fuel cells in the fuel cell stack, said power converter only allowing the oxidation process to be performed when the maximum cell voltage is below a maximum cell voltage threshold and the minimum cell voltage is above a minimum cell voltage threshold.

10. A fuel cell system comprising:
a fuel cell stack including a plurality of fuel cells each having an anode electrode and cathode electrode;
a battery; and
an electrical converter electrically coupled to the battery, said electrical converter being configured to assist in providing an oxidation potential to the fuel cell stack by converting electrical power from the battery at a time effective to oxidize contaminants on the cathode or anode electrodes in the fuel cell stack.

11. The system according to claim 10 wherein the electrical converter is configured to provide a positive potential to the fuel cell stack to oxidize contaminants on the cathode electrodes.

12. The system according to claim 10 wherein the electrical converter is configured to provide a negative potential to the fuel cell stack to oxidize contaminants on the anode electrodes.

13. The system according to claim 10 wherein the battery is a high voltage battery and the electrical converter is a power converter that converts the high voltage from the high voltage battery to the oxidation potential.

14. The system according to claim 10 wherein the battery is a 12 volt battery and the electrical converter is a boost converter that converts and increases the voltage potential from the 12 volt battery to the oxidation potential.

15. The system according to claim 10 wherein the effective time is a time where an amount of hydrogen in the fuel cell stack is known so as to define a reference potential within the stack and there are no system loads drawing power from the fuel cell stack, said oxidation potential being the reference potential plus a voltage potential provided by the electrical converter.

16. The system according to claim 15 wherein the effective time is a time that the fuel cell system is shut-down and hydrogen is being periodically provided to the stack.

17. The system according to claim 15 wherein the effective time is a time that the fuel cell system is in a stand-by mode where the system is operational.

18. A fuel cell system comprising:
a fuel cell stack including a plurality of fuel cells each having an anode electrode;
a high voltage battery; and
a power converter electrically coupled to the battery, said power converter being configured to assist in providing a negative oxidation potential to the fuel cell stack by converting electrical power from the battery at a time effective to oxidize contaminants on the anode electrodes in the fuel cell stack, said effective time being a time when a known amount of hydrogen is being provided to the fuel cell stack.

19. The system according to claim 18 wherein the effective time is a time that the fuel cell system is shut-down and hydrogen is being periodically provided to the stack.

20. The system according to claim 18 wherein the effective time is a time that the fuel cell system is in a stand-by mode where the system is operational.
